(19) United States
(12) Patent Application Publication
(10) Pub. No.: US 2009/0217149 A1
(43) Pub. Date: Aug. 27, 2009

(54) User Extensible Form-Based Data Association Apparatus

(75) Inventors: David G. Kamien, Livingston, NJ (US); Gavin Larowe, Bloomington, IN (US); Shashikant Penumarthy, Bloomington, IN (US); Romit Chatterjee, Calcutta (IN)

Correspondence Address: DARBY & DARBY P.C., P.O. BOX 770, Church Street Station, New York, NY, 10008-0770, US

(73) Assignee: Mind-Alliance Systems, LLC., Roseland, NJ (US)

(21) Appl. No.: 12/368,175

(22) Filed: Feb. 9, 2009

Related U.S. Application Data
(60) Provisional application No. 61/027,361, filed on Feb. 8, 2008.

(51) Int. Cl. G06F 17/00

(52) U.S. Cl. 715/230; 715/764

(57) ABSTRACT

Embodiments of the present invention relate generally to the classification and management of digital data artifacts, and particularly to systems and methods for annotating and associating a comment with a content item available on a computer, TV or mobile (e.g., handheld) device using forms. The digital data artifacts may include at least user-defined and extensible artifacts, or pre-built artifacts, or comments and tags. Comments may include, but are not limited to, one or more of unstructured text, structured data (e.g., data entered or browsed to via a form), an audio or video file, tags, etc. The artifacts may act as a classification system for a user. A method embodying the invention includes navigating to a content item for comment or annotation, and selecting a tag set and/or a form, which is filled in and used to comment on the item and then saved in a database. A tagging or data association server saves the form and user extensible tag set and related files and data sets with the content item and provides various presentation, analysis and information retrieval functionalities. Community responses to the form may be analyzed by semantic analysis and subsequent aggregation and display of the form data.

### CROSS-REFERENCE TO RELATED APPLICATIONS

This application claims priority from U.S. Provisional Patent Application No. 61/027,361, filed Feb. 8, 2008, the entire content of which is hereby incorporated by reference.

### BACKGROUND OF THE INVENTION

Tags are known in the art as a relevant keyword or term associated with or assigned to a piece of information (e.g., a picture, a geographic map, a blog entry, a video clip etc.), thus describing the item and enabling keyword-based classification and search of information. Tags serves as metadata labels or keywords for and a means to organize information and data objects making them findable via search, browsing and other content retrieval and navigation methods. Metadata is generally known as data that provides information about or describes other data.

Tagging, also known as collaborative tagging, folksonomy, social classification, social indexing, etc., is generally known in the art as the practice and method of collaboratively creating and managing tags to annotate and categorize content. In contrast to traditional subject indexing, metadata is not only generated by experts but also by creators and consumers of the content. Usually, freely chosen keywords are used instead of a controlled vocabulary. A controlled vocabulary is generally known in the art as words that are used in subject indexing schemes, subject headings, thesauri and taxonomies. Controlled vocabulary schemes should use predefined, authorized terms that have been preselected by the designer of the controlled vocabulary, as opposed to natural language vocabularies where there is no restriction on the vocabulary that can be used.

Tagging of data on sites such as Delicious™ is performed using free-form tags that are entirely chosen or added at the discretion of the creator. Current state of the art involves a user tagging digital data artifacts (e.g. bookmarks, news articles or blog entries) with personally defined key word tags. This open or unstructured approach to tagging, or concept classification, may be applied, and is closely related, to the practice of social bookmarking whereby a community of users openly share bookmarks based on common tags. Other examples of such systems include Netvouz™, CiteULike™, and Connotea™.

FIGS. 1A-1D illustrate a method of configuring a tagging or data association apparatus according to the background art. In FIG. 1A, a user is viewing a digital artifact and has decided to select it for tagging. The digital artifact of FIG. 1A is shown here as a web page, but more generally may be other kinds of digital artifacts such as a text document, an image, a video via a web browser, etc. FIG. 1B shows the next step, in which the user obtains an identification of the digital artifact, such as a URL (i.e., web address) of the web page, and copies the URL into an input form of known tagging tool, e.g., a web-based tagging tool such as Delicious, Netvouz, CiteULike, Connotea, etc. The user then is also able to add a tag that becomes associated with the URL. The tag may be selected from a predetermined menu of choices, or may be inputted by the user in a free-text field. FIG. 1C shows the next step in which the tag entered by the user in FIG. 1B now has become a referent (i.e., the “item” referenced by or denoted by a separate “item”) to the original URL, i.e., a personal classification label. The user can refer to the tags (e.g., by browsing through them) in order to find a list of URLs of web pages that correspond to the tags. In FIG. 1D, the user provides the selected tag to an application program that is compatible with the digital artifact (e.g., a URL supplied to a web browser), and the application program then presents to the user the digital artifact (e.g., the web page) associated with the tag.

There exist tools that cater to academic communities, and provide more formal classification using resource description languages. For instance, Dublin Core® is known in the art as providing a set of conventions for describing digital materials online in ways that make the digital materials easier to find. Dublin Core is used to describe digital materials such as video, sound, image, text, and composite media like web pages. Another tool is the Metadata Object Description Schema (“MODS”), which is known in the art as an XML-based bibliographic description schema developed by the U.S. Library of Congress, and designed to provide a schema for a bibliographic element set that may be used for a variety of purposes, particularly for library applications. MODS was designed as a compromise between the complexity of a previous format used by libraries and the comparative simplicity of Dublin Core metadata. Dublin Core and MODS store not only user-supplied tags, but also structured citation metadata whenever possible. The provision of rich, structured bibliographical metadata means that the user is provided with an accurate third-party identification of a document or author, which could be used to aid retrieval, but is also free to search on user-supplied terms so that documents of interest (or rather, references to documents) can be made discoverable and aggregated with other similar descriptions either recorded by a particular user or by other users.

Another related technology is off-line and online word processing usage of user-insertable comments as “sticky notes” or right margin comments. However, the user's comments can only contain static and unstructured text. The currently known state of the art does not provide a method to attach structured data to a comment, or to attach dynamically updated data, or video files, all of which contain metadata that can support filtering and browsing of comments.

Folksonomies and user-based tagging are known in the art, at least as described by blogger Ellyssa Kroski at blog web site Blogsome™. Kroski adds to, or expands upon, the terms of art referenced herein; and provides discussion of knowledge of those skilled in the art.

Del.ico.us is known by those skilled in the art as a social bookmarking site. Web bookmarks are saved to a delicious page. The perceived benefit is that users can then access the bookmarks from any internet-connected computer since they are no longer only stored locally. Descriptive keywords may be added to tag the bookmark, facilitating organization of data by category or tag. Users can browse or search other users' bookmarks by the tags.

Flickr is known to those skilled in the art as a digital image storage and management website. Flickr allows organization of photos into albums, tag them with descriptive keywords, and view photos from other users. Flickr allows navigation by tag or user as the previous two sites, as well as by group. Groups are places for users who share similar interests to post their images.

A cognitive analysis of tagging is known in the art, at least as described in one or more publications by Rashmi Sinha.

Proposed scheme(s) using a Namespace Identifier (NID) for one URN which identifies the family of subject-tag metadata, and a family of URNs each of which identifies one subject tag, is known in the art at least by Internet-Draft titled “A Uniform Resource Name (URN) Namespace for Tag Metadata,” submitted to the Internet Engineering Task Force (IETF) Network Working Group, Feb. 1, 2007.

Shortcomings in the tagging scheme implemented in Microsoft Vista™ are known in the art, at least as described by blogger Andreas Stenhall at blog web site The Experience Blog.

### SUMMARY OF THE INVENTION

The present invention relates generally to methods and systems for knowledge management and information retrieval. Embodiments of the present invention relate particularly to systems and methods for associating comments, data sets, tags, and files with referent content items, named entities, and digital data artifacts including an entire document or parts thereof (e.g., words, phrases, sentences and paragraphs) as well as images, photos, maps, video and audio files, and other digital media data types. Comments may include at least one or more of text, audio and visual information.

The present invention provides a mechanism that that enables a group of users to derive improved utility by providing, by the group's users, of additional data and information about the referent. Usage of a form mechanism to structure the added data complements the use of free-form text, and makes the information provided more usable by the group. Because the data itself it is meta-tagged it can be manipulated in useful ways, such as being combined with other data and placed in charts with rows and columns (i.e., a spreadsheet) for analysis and comparison. The selection and use of specific commenting forms also provides useful contextual and ontological characterization of a referent, beyond what is attainable by characterizing the referent with singular tags. The additional data and information may include one or more comments that associate dynamically updated content with the referent, thereby providing a reader with an updated version of related information.

Embodiments of the present invention provide an efficient mechanism for filtering out irrelevant, outdated or unreliable comments, i.e., commentators' referent objects, thereby improving the ability of a user to retrieve and manage relevant data that is tagged with a form.

### BRIEF DESCRIPTION OF THE DRAWINGS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

FIGS. 1A-1D are several views of the configuration of a tagging apparatus according to a technique known in the background art.

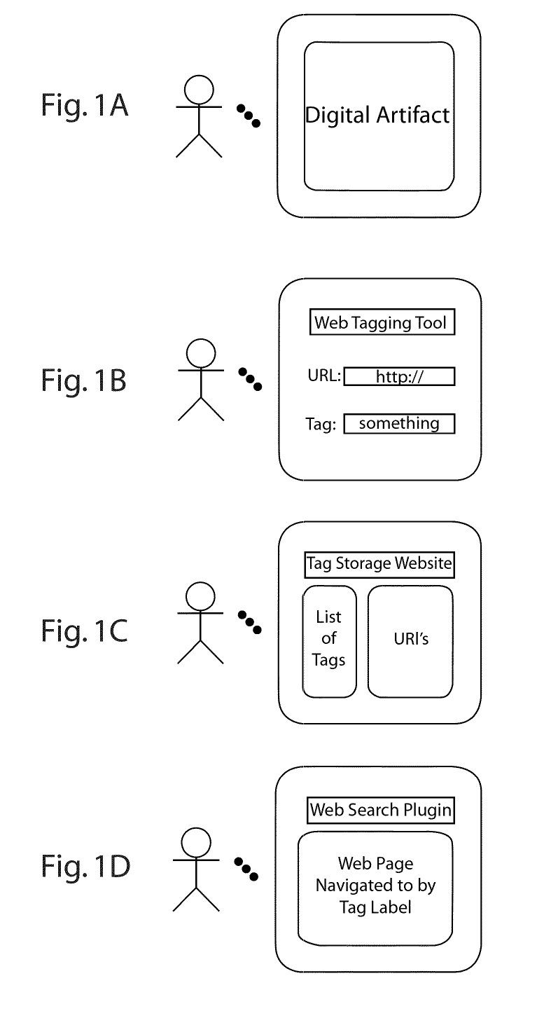

FIG. 2A is an example of a digital artifact without visible tags.

FIG. 2B is an example of the digital artifact of FIG. 2A, along with an input/output form for tags.

FIG. 2C is an example of a digital artifact published with its tags.

FIG. 3 is a screen view of a digital artifact and published comments.

FIG. 4 is a screen view of a digital artifact and published comments, in which a new referent is being delineated.

FIG. 5 is a screen view of the entry of a free-form text comment for a referent.

FIG. 6 is a screen view of the entry of form data for a referent.

FIG. 7 is a screen view of the selection of more information for a published comment.

FIG. 8 is a screen view of the display of form information for a published comment.

FIG. 9 is a screen view of the display of profile information of the author of a published comment.

FIG. 10 is a screen view of the display of additional profile information of the author of a published comment.

FIG. 11 is a screen view of providing filter criteria to comment filter.

### DETAILED DESCRIPTION OF INVENTION

The present invention provides a method to harness the potential of collaboration, in order to produce, discover and present useful information. Embodiments of the present invention provide mechanisms that enable a user or group of users to accurately select, pinpoint and define the context of any kind of referent data object they are annotating, commenting, or otherwise associating data sets, tags, and files with referent content items (e.g., users need to be able to comment not just on an entire news article but comment on a specific word, phrase, sentence paragraph, system user name or profile, part of a photo or another comment).

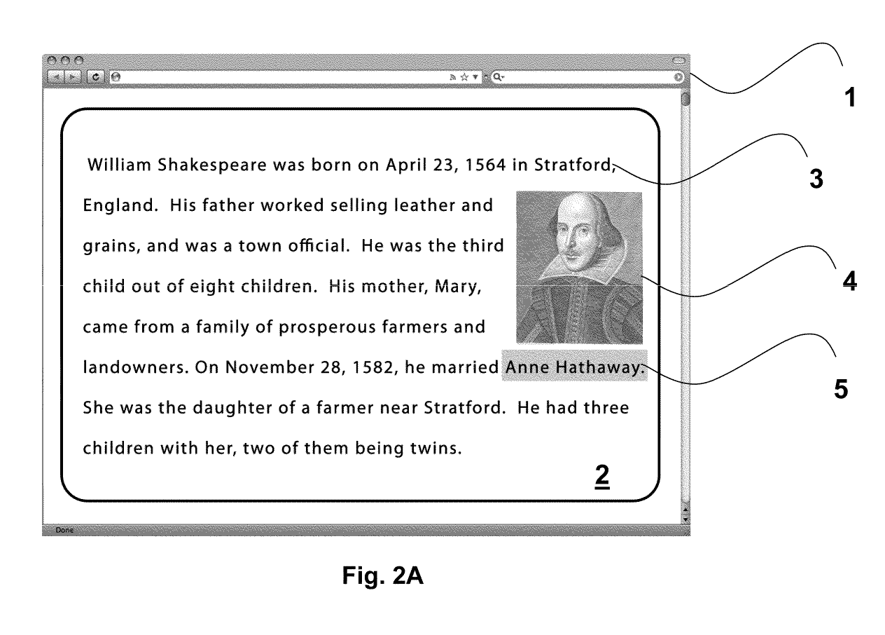

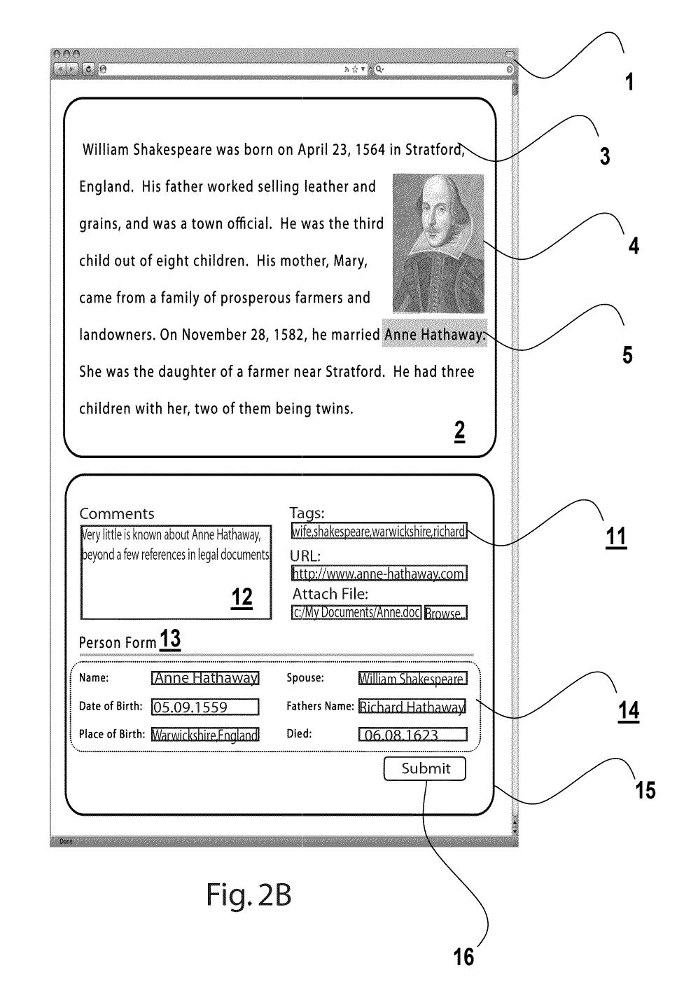

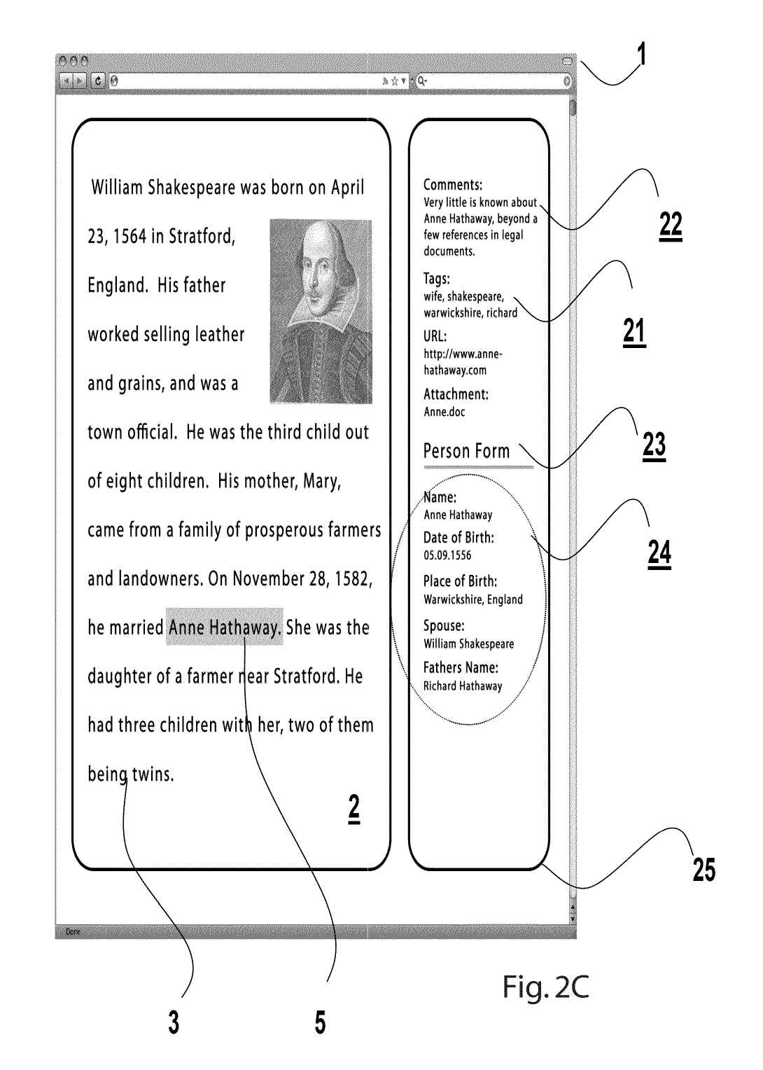

Referring now to FIG. 2A, there is shown an example of a digital artifact to be processed in accordance with embodiments of the invention. FIG. 2A shows a browser display 1 of a web page, the web page representing a digital artifact 2 to be processed. In this example the digital artifact 2 includes textual data 3 and a graphical image 4, but the digital artifact 2 is not limited to these types of data. FIG. 2A further shows that a portion of the digital artifact 2 has been selected by the user and is referred to herein as the referent 5. Referent 5 is the selected part of the digital artifact 2 that a comment will refer to. The referent 5 is highlighted to enable it to be readily identified.

Referring now to FIG. 2B, there is shown an example of a subsequent step in which a form 15 has been added within the browser display 1. Form 15 provides a user interface in which to display information about referent 5, and/or to submit changes (e.g., edits/additions/deletions, etc.) to the information about referent 5. Information within form 15 serves in a broad sense as metadata of referent 5. Form 15 may include, for instance, one or more of the following fields: Tags 11 may be used to provide a short description (e.g., one or more keywords) related to the referent 5; comment box 12 may be provided as an unstructured text field wherein a longer free-form description related to referent 5 may be provided; a form subsection 13 may be provided, in which certain additional information about referent 5 may be provided as form data 14. For example, form data 14 of FIG. 2B provides vital statistics related to referent 5 (e.g., birth/death information; kinship; etc.).

Form subsection 13 and/or form data 14 may be included or omitted in form 15, depending upon, e.g., the nature of the comment information or the referent 5—for instance, the fields shown in form data 14 would not necessarily be relevant if referent 5 instead referred to a geographic location. Additional fields may be provided within form 15, or other forms (not shown) may be provided, for instance, if the comment information includes video—then controls may be provided that are relevant to the type of comment information (e.g., start/pause control; zoom; playback speed, etc.).

Comment box 12 serves as an annotation that refers back to the referent 5. Comments are not limited to a textual nature, and may include other types of information, such as a voice-to-text recording of a comment. Numerous types of files, including video, may be attached to the comment. Similarly, form data 14 is not limited to textual information—for instance, a calendar display may be used for dates, or a map display for geographic locations, or a drawing/painting/photograph to represent persons.

Certain fields within form 15 may have certain restrictions or permissions associated with them which, for instance, may prevent a user from modifying certain fields or to modify certain fields only within certain limits. For instance, referring to FIG. 2B, fields containing birth and death information might be unalterable, whereas a “last modified” field (not shown) may be modifiable only within certain error-checked limits.

Submit button 16 is a control which, when activated by a user, will accept the contents of at least a portion of the fields within form 15, and update a data storage (not shown).

Other embodiments of a user interface may be used beyond the form 15 shown in FIG. 2B. The user may select one or more of a variety of forms. The form-based commenting functionality enables users to annotate documents with data entered or accessed via a form structured with metadata. Said data may be static, or may be updated dynamically by, for instance, request of a user, or at a scheduled time, or upon the occurrence of a Boolean condition (e.g., the value of one field being greater than or less than another field), by an external controller, etc.

Referring now to FIG. 2C, there is shown an example of a subsequent step in which a form 25 has been added within browser display 1. Form 25 presents a published display that cannot be changed by the user, unlike form 15. Embodiments of the invention may be configured to present form 25 upon activation of submit button 16 in form 15. The fields within form 25 are generally similar to the fields within form 15, but do not necessarily need to be identical. For instance, if form 15 contains fields that control the display of form 25, for instance whether form 25 should be presented to the side or on the bottom, or font size, etc. (i.e., metadata of the metadata), then those fields need not be presented in form 25. In another example, the published display may be filtered as described below. Form 25, as depicted in FIG. 2C, includes the following new fields: comments 22, which is a published view of comments field 12; tags 21, which is a published view of tags 11; form 23, which is a published view of form 13; and form data 24, which is a published view of form data 14.

When the submit button of form 15 is activated, the fields within form 15 (e.g., comments 12) are saved and published alongside the digital artifact 2, as depicted in FIG. 2C. Comments can thereafter be filtered using a variety of criteria, including but not limited to: author, date and time, type of form used, existence of attached file or form, or any combination thereof.

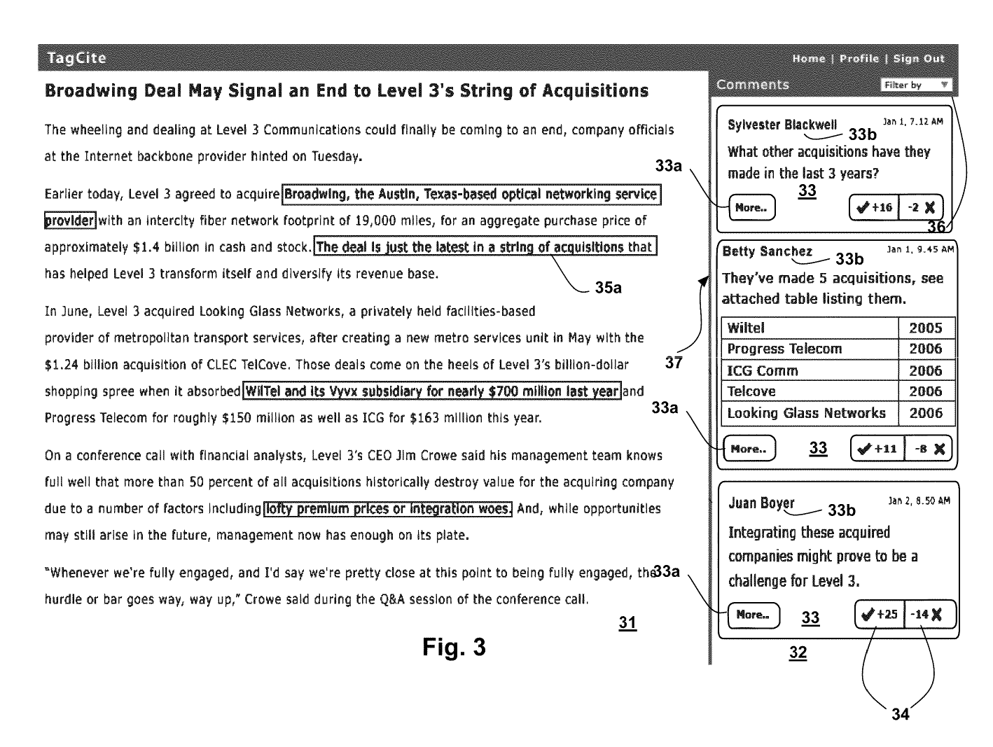

Referring to FIGS. 3-12 there is presented a series of screen shots of a typical application of an embodiment of the invention. FIG. 3 shows a digital artifact 31, containing several highlighted referents, of which referent 35a is identified. A published display 32 is included in the screen, and contains published information about referent 35a. Arrow 37 points to the approximate location of referent 35a within digital artifact 31. A series of comments 33 provided by readers of the digital artifact are shown within the published display 32. The author of the comment 33 may be identified at 33b. Each comment 33 may have a “more” button 33a which provides a control for the user to summon additional information about the subject matter of comment 33. Optionally, any of the comments may include voting buttons 34 with which readers may provide a qualitative assessment of the associated comment. Comments 33 may be filtered by use of a filter control 36, which is described below in further detail.

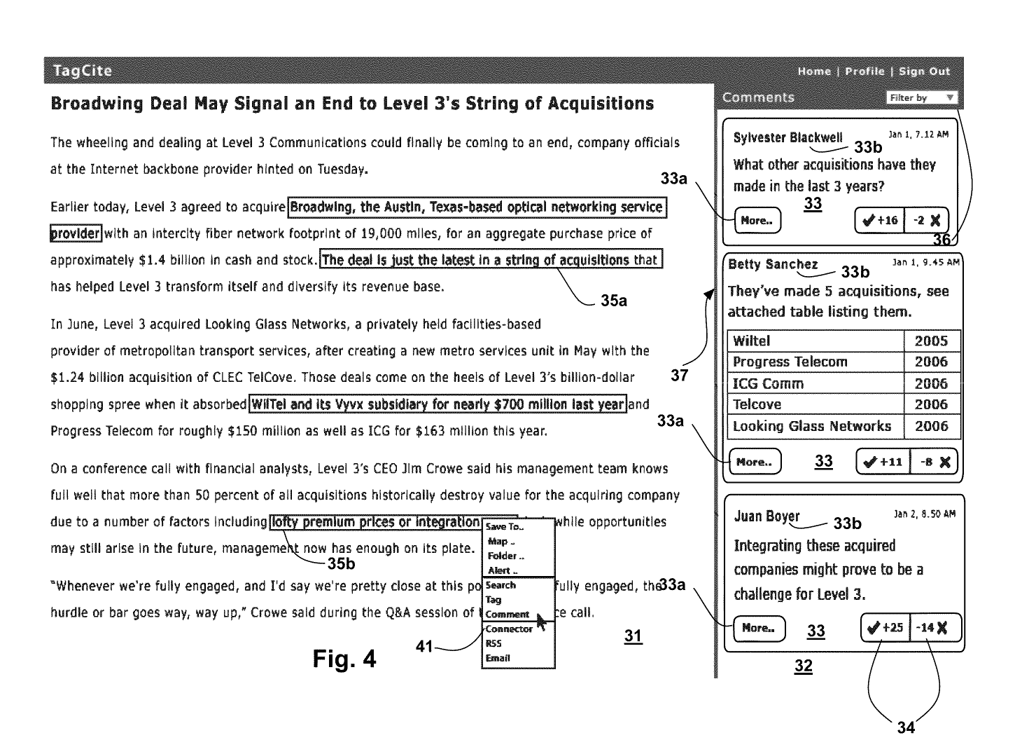

FIG. 4 shows a screen display of a step in which a reader has decided to create a new referent 35b from an existing portion of digital artifact 31. After highlighting the existing portion of digital artifact 31 in order to delineate the proposed referent, a menu 41 is summoned (e.g., by right-mouse click), the menu including relevant menu choices including, e.g., “comment.”

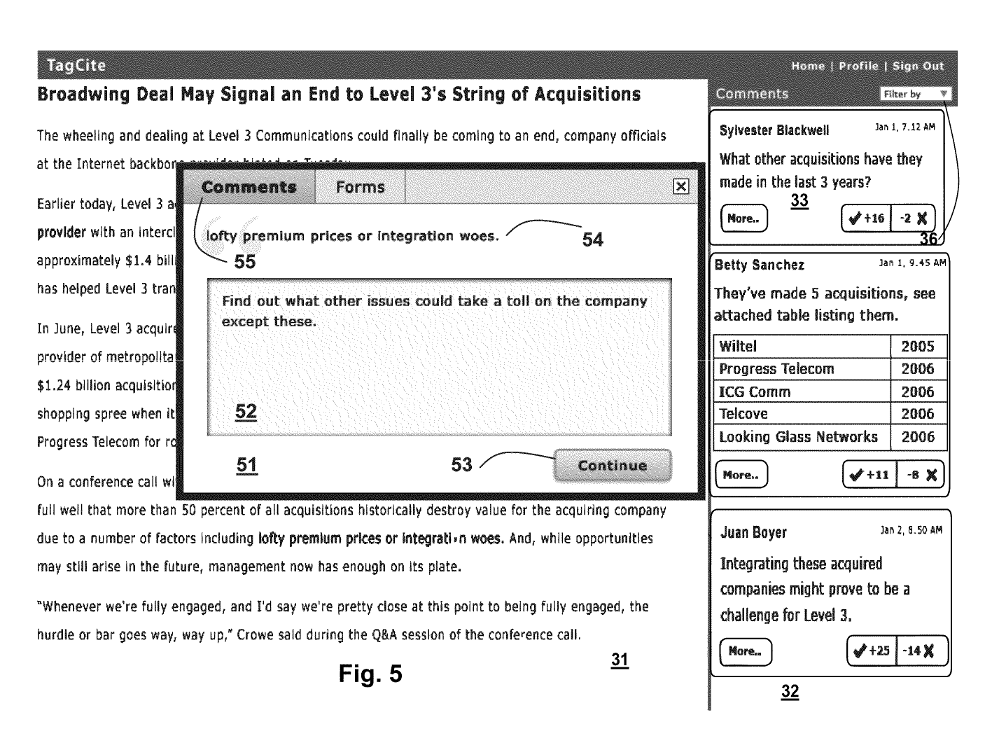

FIG. 5 shows a screen display resulting from selecting the exemplary “comment” menu choice of menu 41, by which a comment can be associated with the proposed new referent 35b. For example, an input window 51 may be displayed, which may include a tabbed interface 55 allowing entry of information, for instance a “comments” tab and “forms” tab. The display of input window 51 may change with a different selection for tabbed interface 55. For instance, FIG. 5 illustrates selection of the “comments” tab, allowing entry of a free-form text comment 52 that will be associated with the referent 35b. The proposed referent is reproduced as text 54.

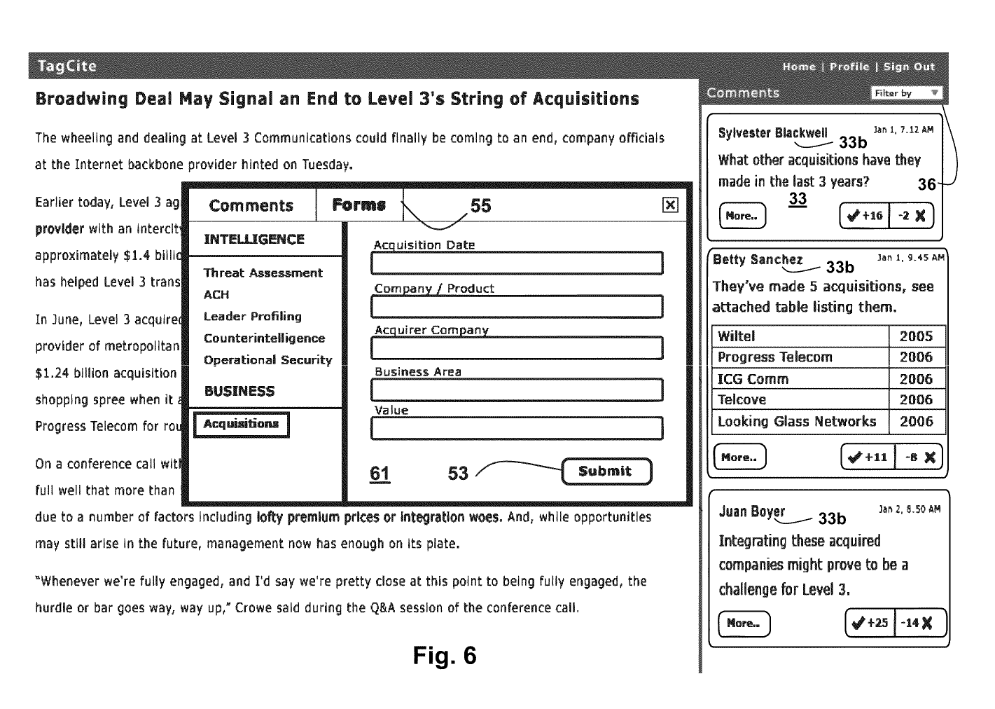

FIG. 6 shows a screen display resulting from selecting the “forms” tab in tabbed interface 55. A different display of input window 51 is presented, suitable for entry of data which is more structured than the free-form text comment 52 data. Input window 51 now includes a mergers and acquisition (“M&A”) window section 61 for entry of more structured data pertaining to M&A. The structure of the data facilitates later searching among the data using predetermined criteria (e.g., having a value greater than a threshold value).

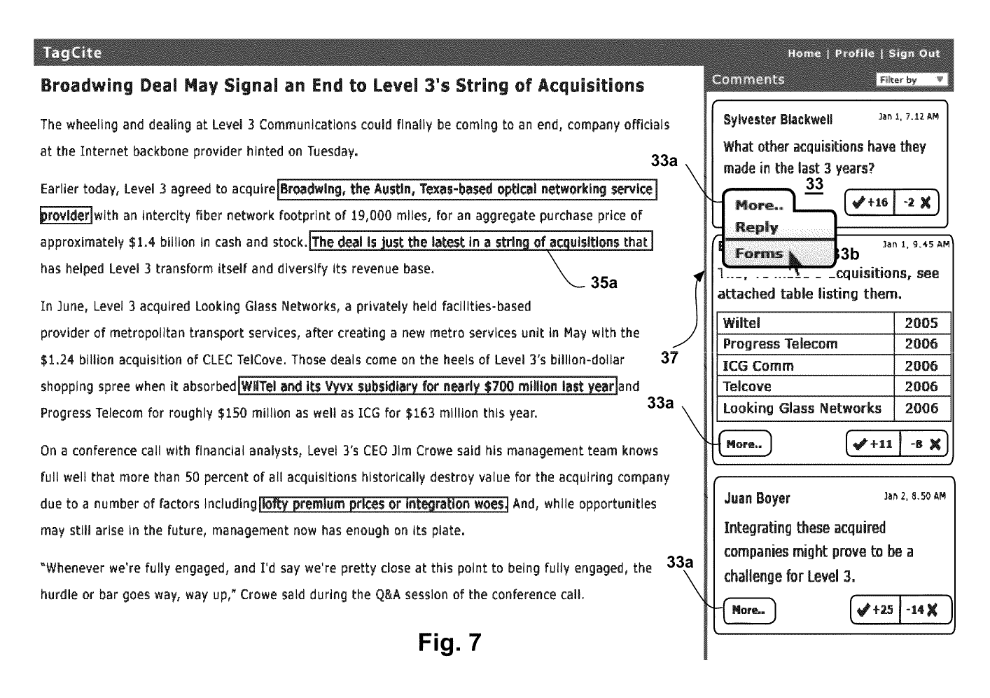

FIG. 7 illustrates the activation of “more” button 35a in order to summon additional information about the subject matter of one of the comments 33, for display and/or editing of the additional information. A submenu may be presented, here shown with menu choices “Reply” and “Forms.”

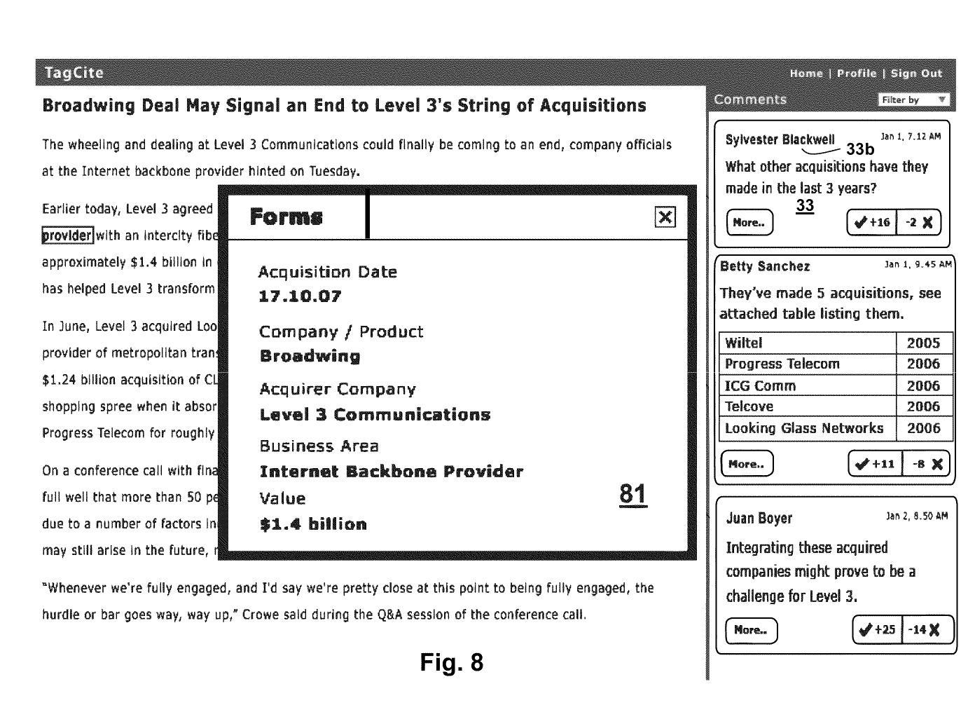

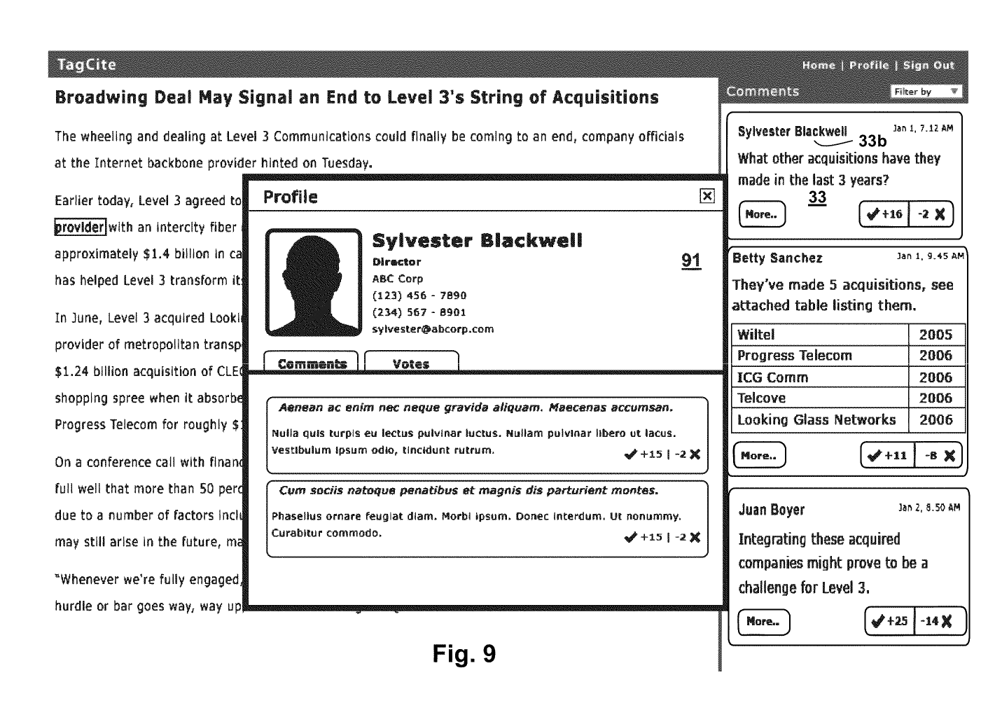

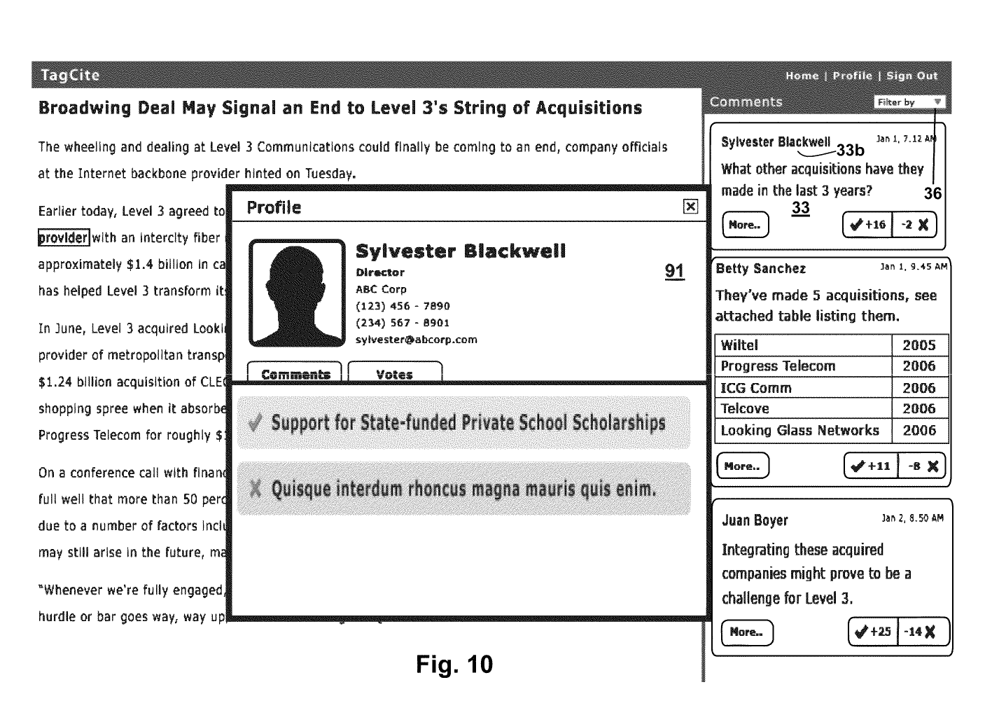

FIG. 8 illustrates the result of selecting the “Forms” menu choice in FIG. 7. A forms sub-window 81 is displayed, showing published information related to the subject matter of the comment 33. FIG. 9 presents a sub-window 91 in which is displayed a profile describing information about author 33b of comment 33. Sub-window 91 may include, for instance, a history of comments made by author 33b, or a history of votes made by the author 33b, or a tally of votes by other users voting on a qualitative assessment of the comments by author 33b. FIG. 10 presents the sub-window 91 displaying additional information about author 33b.

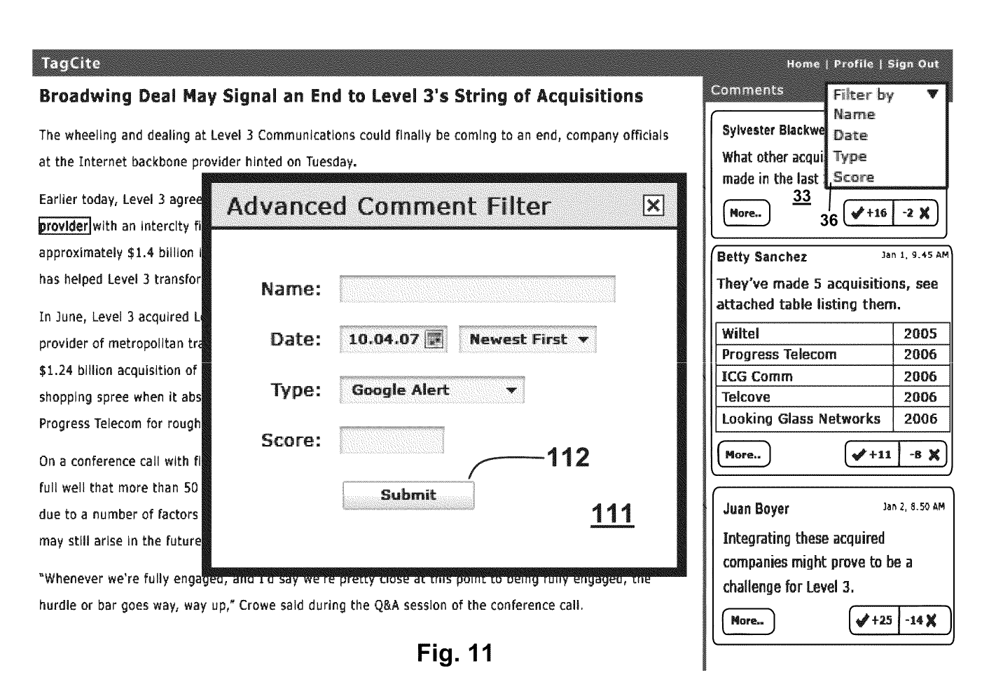

FIG. 11 illustrates operation of filter comment 36 control. Comments 33 may be filtered by, for instance, “name,” “date,” “type,” “score,” etc. Upon selection of the filter comment 36 control, there may be presented a sub-window 111 in which the search criteria may be entered. Upon activation of submit control 112, the comments 33 are filtered according to the selected criteria.

Embodiments of the present invention provide a mechanism for adapting the visual presentation of data so that only those comments and annotations that are relevant are presented in physical proximity to the referent. The table below presents a comparison of this approach to the approach used by some of the related art.

| | | | | Word | The Present |
|---|---|---|---|---|---|
| | Blog | Wiki | Forum | Processing | Invention |
| Select referent | No | No | No | Yes | Yes |
| accurately | | | | | |
| Filter | No | No | No | Limited | Yes |
| comments | | | | | |
| Comment about | Yes | No | Yes, but they | No | Yes |
| comments | | | are not linked | | |
| View | Sometimes | No | Sometimes | Yes | Yes |
| comments in | scrolling is | | scrolling is | | |
| situ with | needed | | needed | | |
| referent | | | | | |
| Include | No | No | No | No | Yes |
| structured data | | | | | |
| & dynamic data | | | | | |
| in comment | | | | | |

An example of usage of an embodiment of the present invention would be to tag a sentence in a financial news article that mentions that a deal is “the latest in a series of string of acquisitions by Company X.” The reader of the article, recognizing it as related to a topic, could tag or annotate the phrase “one of a series of acquisitions” with a free-form text related to that topic that reads, e.g.,: “See attached list of past acquisitions as of this date” and append a to this comment an “M&A form” designed to structure the key details of corporate acquisitions, with metadata such as: Company Name, Acquisition Date, Value, Business Area. FIGS. 3-6, described in detail earlier, present a series of exemplary screen displays that implement the commenting described here.

A second example would be associating the name of a book author with a form that structures the bibliographical information about the author's other published works, with metadata such as: title, Author, Publisher, Subject, Publication date, Language, Price, Hardcopy or softcopy

A third example would be associating the name of a person in an article (i.e., a referent content item) with a form for describing people, which could include such fields as: birth date, gender, nationality, place of residence, college degrees, current professional affiliations, etc.

A fourth example would be associating a paragraph (i.e., a referent content item) where the writer of the text has made an error in reasoning known as a logical fallacy. The person doing the associating would use a form to write a free-form text comment and add a form designed to help classify the type of error as type: “Fallacy of Presumption” and sub-type: “Affirming the Consequent”

A fifth example would be associating an image of a dog on a website or the name of a dog in a blog text sentence with the tag “dog,” or the dog's name (e.g., “Rover”). One can then find mention of Rover by searching among the tags for “dog” and “Rover,” but one cannot know the date of the photo, where the photo was taken, who photographed Rover, how old the dog was at the time, what kind of dog it is and anything else that might be of interest. Now consider that when one ‘tags’ the dog image or text word, one uses a form containing fields and data designed to describe dogs. Such fields might be: breed, date-of-birth, age, weight, color, vaccinations, etc.). The forms, in addition to the tags, provide a far more robust and novel mechanism to supplement description about a given digital object, i.e. a photo of a dog. If one tags Rover with that form, one can now characterize a particular dog far more accurately. As a result, one can later perform a filtered search of all the data and retrieve information about dogs that match numerous criteria: pictures of Rover, my German Sheppard (e.g. pictures taken by one's child over the last three years) and pull up the matching images.

A sixth example would be associating a system user name or contact group name with an appropriate commenting form, which includes a free-form text field as well as forms for describing people and groups. Natural language processing of the text in the free-form text field separately and/or in combination with analysis of the commenting form data would be used to automatically classify the referent contact name, group name or system user name into appropriate categories, obviating the need for manual classification.

A seventh example would be commenting on a person's face in an image showing a group of people, or on a few seconds or minutes of a video recording or stream, perhaps of a presidential debate, and commenting on the content or delivery of the relevant part of the candidate's speech.

There is no limit on the type of forms that could be created and modified by system users, and certain categories of forms would be especially useful, such as those used to describe: bibliography (books, periodicals, websites, patents, legal statutes and case law), people (biographical data), financial information (company data), digital entertainment media (songs, movies, TV shows), products, food, and management tasks and organizations (schools, churches, associations).

As described earlier, there exists tagging with keywords from both controlled and uncontrolled vocabularies. However, there exists no dynamic mechanism for a community of practice or group of users to evolve a controlled vocabulary or a set of tags combined into a form over time. As a result the ability to describe a particular referent is restricted, especially when one observes a digital artifact changing over time. Associating an object or referent using only a single word, even if it is selected from a controlled vocabulary, when contrasted to the approach mentioned above, does not provide enough information to form a robust understanding of a digital artifact, nor the context in which it exists.

Embodiments of the present invention provides a means for users to create, use, add and extend the fields, field-values, presentation, and other aspects of forms used to tag objects. In regards to presentation, one example might be prioritizing the order of the fields by popularity of usage or number of responses received for a given field in the form. Tracking, aggregating, and reporting the results of such responses or inputs allows for a larger orthogonal view for the group-wide analyses regarding the questions in a form, etc.

Another aspect of the present invention is to support an approach to structured classification that can intelligently grow as the community, and usage of the invention, evolves over time.

Structured classification typically involves controlled vocabularies. A controlled vocabulary may be a carefully selected list of words and phrases, which are used to tag units of information (document or work) so that they may be more easily retrieved by a search. They attempt to solve the problem of homonymy, synonymy, and polysemy in the context of word meaning disambiguation for classification. As is generally known in the art: homonymy is one of a group of words that share the same spelling and the same pronunciation but have different meanings, or the state of being a homonym; synonymy refers to different words with similar or identical meanings, or the state of being a synonym; and polysemy refers to the capacity for sign(s) (e.g., a word, phrase, etc.) to have multiple meanings (i.e., sememes, or a large semantic field).

A pertinent example of a controlled vocabulary is the Library of Congress Subject Heading fields. A description of Library of Congress Subject Headings may be found within the General Collections of the Library of Congress. In the process of associating a document with a particular form, embodiments of the invention allow a user to associate a digital artifact with a word or form derived from a controlled vocabulary.

Another aspect of this invention is the linking of a digital object to an instantiation of a Form-Based Data Association Apparatus. Clicking on a link, icon or button placed next to a digital object could insert that digital object (e.g., text article or photo) into the form-based data association apparatus, if it were not already there, making it available for form-based association. If the object has already been imported into the association system, then clicking on the icon brings the user into the relevant part of the association system where he or she can commence adding and viewing comments and tags.

Another aspect of the invention is to provide a means for showing, via visual analytical techniques, how classification of an object by a first individual or a first group relates to classification of an object by a second individual or a second group. Embodiments of the invention allow viewing how any classification, and/or the opinion or view of a referent, has evolved over time. In addition, embodiments of the invention allow furnishing a novel graphical way to understand the evolution of how people classify and conceptualize a given object or concept over time, when that information is juxtaposed next to the text-based tags and forms.

Summarily, the interchange between a user, a document, the tags used to classify a digital document or digital artifact, and the forms used to provide this supplementary association ability are envisioned to encapsulate the verbal dialogue that normally occurs between a group of users and their communication encompassing their understanding of a given document or digital artifact. The digital artifact, the tags, plus the innovative use of forms as system of classification taken together provide a bridge to digital evolving dialogues in the realm of the World Wide Web.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A processor-implemented method of associating an organizable comment to a digital object, the method comprising the steps of:
enabling at least a portion of the digital object to be identified by a user;
accepting an identification, by the user, of at least the portion of the digital object, to produce a referent;
presenting an input form to allow entry of a comment;
accepting the comment, to produce a structured comment; and
storing the structured comment and an association to the referent, to produce an organizable comment.

2. The processor-implemented method of claim 1, wherein the digital object comprises information displayable by a web browser.

3. The processor-implemented method of claim 1, wherein the comment comprises audio/visual information.

4. The processor-implemented method of claim 1, wherein the comment comprises an unstructured text field.

5. The processor-implemented method of claim 1, wherein the comment comprises one or more structured fields.

6. The processor-implemented method of claim 5, wherein the one or more structured fields comprises a controlled vocabulary.

7. The processor-implemented method of claim 1, wherein the comment comprises a metadata of the referent.

8. The processor-implemented method of claim 1, wherein the comment comprises a metadata of the comment.

9. The processor-implemented method of claim 1, wherein the digital object is displayable with at least a portion of the organizable comment.

10. The processor-implemented method of claim 1, wherein the organizable comment is filterable by content.

11. The processor-implemented method of claim 1, wherein the organizable comment includes a qualitative feedback capability.

12. The processor-implemented method of claim 1, wherein the organizable comment includes a capability to add a second organizable comment.

13. The processor-implemented method of claim 12, wherein an input form of the second organizable comment is selected from a menu.

14. The processor-implemented method of claim 1, wherein the organizable comment is updateable.

15. The processor-implemented method of claim 14, wherein the updateable comment is updated by querying a database.

16. The processor-implemented method of claim 1, wherein clicking on a control coupled to a nonassociated digital object will associate the nonassociated digital object with an organizable comment.

17. The processor-implemented method of claim 1, further comprising comparing structured comments by a first user to structured comments from a second user.

18. The processor-implemented method of claim 1, wherein the referent relates to a topic, and the structured comment relates to the topic.

19. The processor-implemented method of claim 1, wherein the referent relates to a publication, and the structured comment relates to the publication.

20. The processor-implemented method of claim 1, wherein the referent relates to a person, and the structured comment relates to information about the person.

21. The processor-implemented method of claim 1, wherein the referent relates to a statement, and the structured comment relates to a refutement of the statement.

22. The processor-implemented method of claim 1, wherein the referent relates to an audio/visual object, and the structured comment relates to feedback on the audio/visual object.

23. The processor-implemented method of claim 1, wherein a first content of the structured comment is used to derive a second content of the structured content using natural language processing of the first content.

24. A processor-implemented apparatus to associate an organizable comment to a digital object, the apparatus comprising:
an input device enabling at least a portion of the digital object to be identified by a user;
an output device configured to present a form to allow entry of a comment related to the portion of the digital object;
a processor configured to accept an identification, by the user, of at least the portion of the digital object, to produce a referent, the processor further accepting the comment, to produce a structured comment; and
a storage device to store the structured comment and an association to the referent, to produce an organizable comment.

25. A processor-implemented method of commenting on a digital object, the method comprising the steps of:
presenting the digital object to a user by use of the processor;
enabling at least a portion of the digital object to be identified by the user;
accepting an identification, by the user, of at least the portion of the digital object, to produce a referent;
producing a visual identification of the referent;
presenting an input form to allow entry of a comment;
accepting the comment, to produce a structured comment;
data-checking the content of the structured comment, to produce data-checked structured comment;
associating the data-checked structured comment to the referent, to produce an association to the referent; and
storing the data-checked structured comment and the association to the referent, to produce an organizable comment.

26. A processor-implemented method of presenting a commented digital object, the method comprising the steps of:
retrieving a digital object from a first data storage;
determining an association of the digital object to a structured comment, to identify an associated structured comment;
retrieving the associated structured comment from a second data storage; and
presenting the digital object and the associated structured comment to a user together, by use of the processor, to present a commented digital object.

27. The processor-implemented method of claim 26, wherein the associated structured comment further comprises a quality indicator.

28. The processor-implemented method of claim 26, wherein the associated structured comment further comprises a control to update the associated structured comment.

29. The processor-implemented method of claim 26, wherein the method further comprises the step of automatically updating the presented associated structured comment from data from a data storage.

30. The processor-implemented method of claim 29, wherein the method further comprises the step of initiating the updating of the presented associated structured comment based on the occurrence of a predetermined Boolean condition.
